(19) United States
(12) Patent Application Publication
(10) Pub. No.: US 2026/0269738 A1
(43) Pub. Date: Sep. 10, 2026

(54) RECTIFIER WITH IMPEDANCE CONTROL CIRCUIT

(71) Applicant: FOUNDATION OF SOONGSIL UNIVERSITY-INDUSTRY COOPERATION, Seoul (KR)

(72) Inventors: JUN TAEK OH, Seoul (KR); JAEMIN SHIN, Seoul (KR)

(21) Appl. No.: 19/300,913

(22) Filed: Aug. 15, 2025

(30) Foreign Application Priority Data
Mar. 6, 2025 (KR) 10-2025-0029175

(51) Int. Cl. H02M 7/06; H02M 1/12

(52) U.S. Cl. CPC H02M 7/06; H02M 1/12

(57) ABSTRACT

A rectifier with an impedance control circuit includes an input node, an output node, a first diode connected to the input node and a ground terminal, and a second diode connected to the input node and the output node. The rectifier may further include a first harmonic impedance control circuit connected to the first diode and the ground terminal and configured to control second and third harmonic impedances in the first diode and a second harmonic impedance control circuit connected to the second diode and the output node and configured to control second and third harmonic impedances in the second diode.

### CROSS-REFERENCE TO RELATED APPLICATION AND CLAIM OF PRIORITY

This application claims the benefit under 35 USC § 119 of Korean Patent Application No. 10-2025-0029175, filed on Mar. 6, 2025, in the Korean Intellectual Property Office, the entire disclosure of which is incorporated herein by reference for all purposes.

### BACKGROUND

### 1. Field

Embodiments of the present disclosure relate to a rectifier with an impedance control circuit.

### 2. Description of Related Art

A rectifier is a key circuit that converts an AC signal into a DC signal and is utilized for energy harvesting and wireless power transmission. There are various methods for achieving high power conversion efficiency, and among the methods, a harmonic impedance control method is attracting attention as an efficient alternative. In particular, a Class-F rectifier is designed to minimize the overlap of voltage and current waveforms applied to a diode by controlling the second and third harmonic impedances, thereby reducing the power loss of the diode and maximizing the power conversion efficiency of the diode. However, the Class-F rectifier is limited in its ability to consistently maintain high power conversion efficiency as frequency changes or input power changes.

To overcome this, a voltage multiplier-based Class-F rectifier structure is emerging as an alternative. The voltage multiplier structure has the advantage of maintaining high power conversion efficiency even under various conditions with relatively small impedance fluctuations due to frequency and input power changes.

Accordingly, based on these characteristics, the voltage multiplier-based Class-F rectifier that can provide stable high power conversion efficiency even under frequency changes and input power changes is being studied. The voltage multiplier-based Class-F rectifier should have the characteristics of accurately controlling the second and third harmonic impedances (0 ohm for the second harmonic impedance and infinity for the third harmonic impedance) while being matched to 50 ohms at the fundamental frequency.

However, the conventional voltage multiplier-based Class-F rectifier cannot accurately control the harmonic impedance independently in each diode, and requires an additional fundamental matching stage, and thus the design complexity increases and the circuit area and development cost increase, which are problematic.

Examples of related art include Korean Unexamined Patent Application Publication No. 10-2021-0003712 (Jan. 12, 2021).

### SUMMARY

Embodiments of the present disclosure are directed to providing a rectifier with an impedance control circuit.

According to an exemplary embodiment of the present disclosure, there is provided a rectifier including an input node, an output node, a first diode connected to the input node and a ground terminal, and a second diode connected to the input node and the output node, and the rectifier further includes a first harmonic impedance control circuit connected to the first diode and the ground terminal and configured to control second and third harmonic impedances in the first diode and a second harmonic impedance control circuit connected to the second diode and the output node and configured to control second and third harmonic impedances in the second diode.

The rectifier may further include a first capacitor configured to block a DC component of an electrical signal provided from the input node, a DC pass filter connected to the second harmonic impedance control circuit and the output node, and a second capacitor connected to the second harmonic impedance control circuit and configured to amplify a voltage of the electrical signal.

The first harmonic impedance control circuit may further include a first transmission line of which one end is connected to an anode of the first diode and the other end is connected to a first node, a second transmission line of which one end is connected to the first node and the other end is connected to the ground terminal, and a first open stub of which one end is connected to the first node and which is connected in parallel with the second transmission line.

The first transmission line and the first open stub may have a length obtained by dividing a wavelength corresponding to the third harmonic frequency in the first diode by four so that the third harmonic impedance in the first diode is controlled to infinity by the first harmonic impedance control circuit.

The first transmission line, the first open stub, and the second transmission line may have adjusted values of a thickness of the first transmission line, a thickness of the first open stub, and a thickness and length of the second transmission line so that the second harmonic impedance in the first diode is controlled to 0 ohm by the first harmonic impedance control circuit.

The thickness of the first transmission line, the thickness of the first open stub, and the thickness and length of the second transmission line may be adjusted so that an input impedance measured at the first node is calculated based on Equations 1 and 2 below, and an impedance to the second harmonic at the first diode is 0 ohm based on Equation 3 below,

$${Z}_{IN \_ TL 2} = \frac{{Z}_{0 \_ TL 2}}{j tan ( \frac{π}{6} \frac{f}{{f}_{0}} )} at f = 2 {f}_{0} \qquad [ Equation 1 ]$$

(where, Z_{IN_TL2} is input impedance of first open stub, Z_{0_TL2} is characteristic impedance (thickness) of first open stub),

$${Z}_{IN \_ TL 3} = j {Z}_{0 \_ TL 3} tan ( \frac{7 π}{36} \frac{f}{{f}_{0}} ) at f = 2 {f}_{0} \qquad [ Equation 2 ]$$

(where, Z_{IN_TL3} is input impedance of second transmission line, Z_{0_TL3} is characteristic impedance (thickness) of second transmission line), and

$${Z}_{IN \_ HCN 1} = {Z}_{0 \_ HCN 1} \frac{{Z}_{IN \_ TL 2 , TL 3} + j {Z}_{0 \_ HCN 1} tan ( \frac{π}{6} \frac{f}{{f}_{0}} )}{{Z}_{0 \_ HCN 1} + j {Z}_{IN \_ TL 2 , TL 3} tan ( \frac{π}{6} \frac{f}{{f}_{0}} )} \qquad [ Equation 3 ]$$

$$at f = 2 {f}_{0}$$

(where, Z_{IN_HCN1} is input impedance of first harmonic impedance control circuit, Z_{0_HCN1} is characteristic impedance of first transmission line in first harmonic impedance control circuit, Z_{IN_TL2,TL3} is input impedance measured at first node, f₀ is fundamental frequency, and f is second harmonic frequency).

The first transmission line, the second transmission line and the first open stub may have adjusted values of the thickness of the first transmission line, the thickness of the first open stub and the thickness and length of the second transmission line so that the input impedance at the input node is matched to 50 ohms at the fundamental frequency by adjusting the input impedance at the first diode by the first harmonic impedance control circuit.

The second harmonic impedance control circuit may further include a third transmission line of which one end is connected to a cathode of the second diode and the other end is connected to a second node, a fourth transmission line of which one end is connected to the second node and the other end is connected to the output node, and a second open stub of which one end is connected to the second node and which is connected in parallel with the fourth transmission line.

The third transmission line and the second open stub may have a length obtained by dividing a wavelength corresponding to the third harmonic frequency in the second diode by four so that the third harmonic impedance in the second diode is controlled to infinity by the second harmonic impedance control circuit.

The third transmission line, the second open stub, and the fourth transmission line may have adjusted values of a thickness of the third transmission line, a thickness of the second open stub, and a thickness and length of the fourth transmission line so that the second harmonic impedance in the second diode is controlled to 0 ohm by the second harmonic impedance control circuit.

The thickness of the third transmission line, the thickness of the second open stub, and the thickness and length of the fourth transmission line may be adjusted so that an input impedance measured at the second node is calculated based on Equations 4 and 5 below, and an impedance to the second harmonic at the second diode is 0 ohm based on Equation 6 below,

$${Z}_{IN \_ TL 5} = \frac{{Z}_{0 \_ TL 5}}{j tan ( \frac{π}{6} \frac{f}{{f}_{0}} )} at f = 2 {f}_{0} \qquad [ Equation 4 ]$$

(where, Z_{IN_TL5} is input impedance of second open stub, Z_{0_TL5} is characteristic impedance (thickness) of second open stub),

$${Z}_{IN \_ TL 6} = {Z}_{0 \_ TL 6} \frac{{Z}_{L \_ TL 6} + {jZ}_{0 \_ TL 6} tan ( \frac{27 π}{200} \frac{f}{{f}_{0}} )}{{Z}_{0 \_ TL 6} + {jZ}_{L \_ TL 6} tan ( \frac{27 π}{200} \frac{f}{{f}_{0}} )} at f = 2 {f}_{0} \qquad [ Equation 5 ]$$

(where, Z_{IN_TL6} is input impedance of fourth transmission line, Z_{0_TL6} is characteristic impedance (thickness) of fourth transmission line), and

$${Z}_{IN \_ HCN 2} = {Z}_{0 \_ HCN 2} \frac{{Z}_{IN \_ TL 5 , TL 6} + j {Z}_{0 \_ HCN 2} tan ( \frac{π}{6} \frac{f}{{f}_{0}} )}{{Z}_{0 \_ HCN 2} + j {Z}_{IN \_ TL 5 , TL 6} tan ( \frac{π}{6} \frac{f}{{f}_{0}} )} \qquad [ Equation 6 ]$$

$$at f = 2 {f}_{0}$$

(where, Z_{IN_HCN2} is input impedance of second harmonic impedance control circuit, Z_{0_HCN2} is characteristic impedance of third transmission line in second harmonic impedance control circuit, Z_{IN_TL5,TL6} is input impedance measured at the second node, f₀ is fundamental frequency, and f is second harmonic frequency).

The third transmission line, the second open stub, and the fourth transmission line may have adjusted values of the thickness of the third transmission line, the thickness of the second open stub, and the thickness and length of the fourth transmission line so that the input impedance at the input node is matched to 50 ohms at the fundamental frequency by adjusting the input impedance at the second diode by the second harmonic impedance control circuit.

### BRIEF DESCRIPTION OF THE DRAWINGS

FIG. 1 is a conceptual diagram for describing a configuration of a rectifier with an impedance control circuit according to an embodiment of the present disclosure.

FIG. 2 is a circuit diagram for describing the rectifier with an impedance control circuit according to an embodiment of the present disclosure.

FIG. 3A to FIG. 6 are diagrams showing simulation results of a rectifier with an impedance control circuit according to an embodiment of the present disclosure.

FIGS. 7A and 7B are diagrams showing performance characteristics of a rectifier with an impedance control circuit according to an embodiment of the present disclosure.

### DETAILED DESCRIPTION

Hereinafter, specific embodiments of the present disclosure will be described with reference to the drawings. The following detailed description is provided to aid in a comprehensive understanding of the methods, devices and/or systems described herein. However, this is only an example and the present disclosure is not limited thereto.

In describing embodiments of the present disclosure, when it is determined that a detailed description of a known technology related to the present disclosure may unnecessarily obscure the gist of the present disclosure, the detailed description thereof will be omitted. In addition, the terms described below are terms defined in consideration of their functions in the present disclosure and may vary depending on the intention or custom of the user or operator. Therefore, the definition should be made based on the contents throughout this specification. The terms used in the detailed description are only for describing embodiments of the present disclosure and should not be considered limiting. Unless clearly used otherwise, expressions in the singular form include the meaning of the plural form. In this description, expressions such as “including” or “comprising” are intended to indicate certain features, numbers, steps, operations, elements, parts or combinations thereof, and should not be construed to exclude the presence or possibility of one or more other features, numbers, steps, operations, elements, parts or combinations thereof other than those described.

In addition, terms such as first, second, etc. may be used to describe various components, but the components should not be limited by the terms. Terms may be used for the purpose of distinguishing one component from another. For example, without departing from the scope of the present disclosure, a first component may be referred to as a second component, and similarly, a second component may also be referred to as a first component.

In the following description, the terms “transfer”, “communication”, “transmission”, “reception”, and other similar terms of a signal or information include not only direct transmission of the signal or information from one component to another, but also transmission via another component. In particular, “transferring” or “transmitting” a signal or information to one component indicates the final destination of the signal or information, and does not mean the direct destination. The same applies to “reception” of a signal or information. In addition, in this specification, the fact that two or more pieces of data or information are “related” means that when one piece of data (or information) is acquired, at least a portion of the other data (or information) may be acquired based on it.

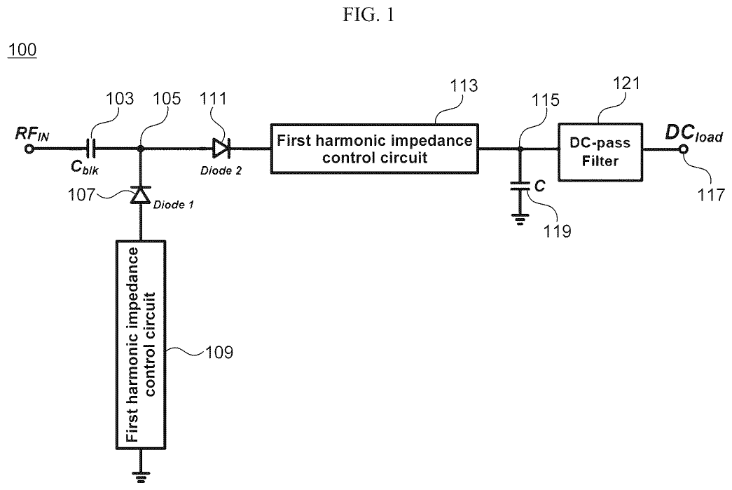

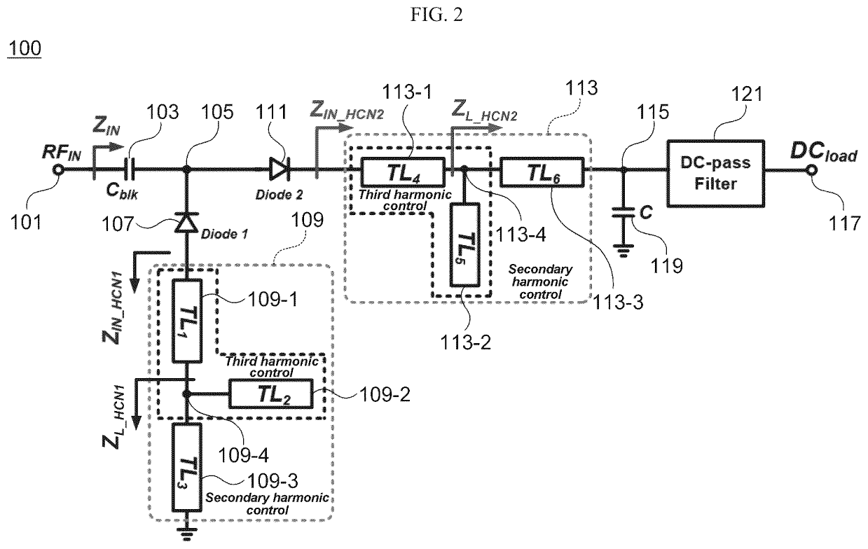

FIG. 1 is a conceptual diagram for describing the configuration of a rectifier with an impedance control circuit according to an embodiment of the present disclosure and FIG. 2 is a circuit diagram for describing the rectifier with an impedance control circuit according to an embodiment of the present disclosure.

Meanwhile, a rectifier 100 with the impedance control circuit of the present disclosure is a Class-F rectifier for controlling second and third harmonic impedances, and may have a voltage multiplier structure.

Referring to FIG. 1 and FIG. 2, the rectifier 100 with the impedance control circuit may include an input node 101, a first capacitor 103, a first diode 107, a first harmonic impedance control circuit 109, a second diode 111, a second harmonic impedance control circuit 113, and an output node 117.

The input node 101 may receive an electrical signal from the outside. For example, the input node 101 may be connected to a power source.

The first capacitor 103 is a blocking capacitor, and may block a DC component from an electrical signal provided from the input node 101. This blocking capacitor blocks the DC component and allows AC signal to pass through to a diode, and adjust a path of fundamental and harmonic signals to minimize signal loss. For example, one end of the first capacitor 103 may be connected to the input node 101. The other end of the first capacitor 103 may be connected to a first node 105.

A cathode of the first diode 107 may be connected to the first node 105 and an anode thereof is connected to the first harmonic impedance control circuit 109. The first diode 107 may form a current path between the first node 105 and the ground terminal.

An anode of the second diode 111 may be connected to the first node 105 and a cathode thereof may be connected to the second harmonic impedance control circuit 113. The second diode 111 may form a current path between the first node 105 and the output node 117.

Meanwhile, the first diode 107 and the second diode 111 rectify the AC signal transmitted from the first capacitor 103 and output a DC signal, and the output DC signal includes harmonic components. In this case, the rectifier 100 with an impedance control circuit according to an embodiment of the present disclosure controls the second harmonic and the third harmonic in the first diode 107 and the second diode 111 by the first harmonic impedance control circuit 109 and the second harmonic impedance control circuit 113 (0 ohm for the second harmonic and infinity for the third harmonic). The first harmonic impedance control circuit 109 and the second harmonic impedance control circuit 113 will be described below.

The first harmonic impedance control circuit 109 may be connected between the anode of the first diode 107 and the ground terminal.

In an exemplary embodiment, the first harmonic impedance control circuit 109 may include a first transmission line 109-1 of which one end is connected to the anode of the first diode 107 and the other end is connected to a third node 109-4, a second transmission line 109-3 of which one end is connected to the third node 109-4 and the other end is connected to the ground terminal, and a first open stub 109-2 connected to the third node 109-4.

That is, the first harmonic impedance control circuit 109 may control the third harmonic impedance to infinity through the first transmission line 109-1 and the first open stub 109-2 connected to the third node 109-4. In this case, the first transmission line 109-1 and the first open stub 109-2 may have a length of one-quarter of a third harmonic wavelength (2). In addition, the first harmonic impedance control circuit 109 may control the second harmonic impedance to 0 ohm through the first transmission line 109-1, the first open stub 109-2, and the second transmission line 109-3 connected in series to the first transmission line 109-1. In this case, for the first transmission line 109-1, the first open stub 109-2, and the second transmission line 109-3, a thickness of the first transmission line 109-1, a thickness of the first open stub 109-2, and a thickness and length of the second transmission line 109-3 may be determined through an optimization process based on an impedance formula so that the second harmonic impedance is controlled to 0 ohm.

Hereinafter, a process of controlling the third harmonic impedance using the first harmonic impedance control circuit 109 will be described.

Equation 1 below is a formula that represents the basic impedance relationship.

$${Z}_{IN \_ HCN 1} = {Z}_{0 \_ HCN 1} \frac{{Z}_{L \_ HCN 1} + j {Z}_{0 \_ HCN 1} tan ( \frac{π}{6} \frac{f}{{f}_{0}} )}{{Z}_{0 \_ HCN 1} + j {Z}_{L \_ HCN 1} tan ( \frac{π}{6} \frac{f}{{f}_{0}} )} at f = 3 {f}_{0} \qquad [ Equation 1 ]$$

(where, Z_{IN_HCN1} is an input impedance of the first harmonic impedance control circuit, Z_{0_HCN1} is a characteristic impedance (thickness) of the first transmission line in the first harmonic impedance control circuit, Z_{L_HCN1} is the load impedance of the first harmonic impedance control circuit, f₀ is a fundamental frequency, and f is a third harmonic frequency)

In this case, since the load impedance to the third harmonic is represented as 0 by the first open stub 109-2, Equation 1 above may be defined as Equation 3 below by Equation 2 below.

$${Z}_{IN \_ TL 2} = \frac{{Z}_{0 \_ TL 2}}{j tan ( \frac{π}{6} \frac{f}{{f}_{0}} )} at f = 3 {f}_{0} \qquad [ Equation 2 ]$$

(where, Z_{IN_TL2} is the input impedance of the first open stub and Z_{0_TL2} is the characteristic impedance (thickness) of the first open stub)

$${Z}_{IN \_ HCN 1} = j {Z}_{0 \_ HCN 1} tan ( \frac{π}{6} \frac{f}{{f}_{0}} ) at f = 3 {f}_{0} \qquad [ Equation 3 ]$$

In this case, since the first transmission line 109-1 is designed to have a length of one-quarter of the third harmonic wavelength, the impedance to the third harmonic may be controlled to infinity in the first diode 107.

Hereinafter, a process of controlling the second harmonic impedance using the first harmonic impedance control circuit 109 will be described.

Equation 4 below is a formula representing the input impedance Z_{IN} of the rectifier according to the voltage multiplier structure.

$${Z}_{IN} = ( {Z}_{IN \_ HCN 1} ‖ {Z}_{IN \_ HCN 2} ) + Z ( {C}_{b l k} ) at f = {f}_{0} \qquad [ Equation 4 ]$$

In order to control the second harmonic impedance to 0, the input impedance measured at the third node 109-4 (the input impedance measured at the point where the first open stub 109-2 and the second transmission line 109-3 are connected in parallel) should be controlled.

In this case, the input impedances of the first open stub 109-2 and the second transmission line 109-3 may be defined as in Equations 5 and 6 below, respectively.

$${Z}_{IN \_ TL 2} = \frac{{Z}_{0 \_ TL 2}}{j tan ( \frac{π}{6} \frac{f}{{f}_{0}} )} at f = 2 {f}_{0} \qquad [ Equation 5 ]$$

(where, Z_{IN_TL2} is the input impedance of the first open stub and Z_{0_TL2} is the characteristic impedance (thickness) of the first open stub).

$${Z}_{IN \_ TL 3} = {jZ}_{0 \_ TL 3} tan ( \frac{7 π}{36} \frac{f}{{f}_{0}} ) at f = 2 {f}_{0} \qquad [ Equation 6 ]$$

(where, Z_{IN_TL3} is the input impedance of the second transmission line and Z_{0_TL3} is the characteristic impedance (thickness) of the second transmission line)

Based on the input impedances of the first open stub 109-2 and the second transmission line 109-3, the input impedance Z_{IN_TL2,TL3} measured at the third node 109-4 may be calculated. Using the calculated input impedance, the first diode 107 may be optimized to control the impedance to the second harmonic to 0 ohm based on Equation 7 below.

$${Z}_{IN \_ HCN 1} = {Z}_{0 \_ HCN 1} \frac{{Z}_{IN \_ TL 2 , TL 3} + {jZ}_{0 \_ HCN 1} tan ( \frac{π}{6} \frac{f}{{f}_{0}} )}{{Z}_{0 \_ HCN 1} + {jZ}_{IN \_ TL 2 , TL 3} tan ( \frac{π}{6} \frac{f}{{f}_{0}} )} at \\ f = 2 {f}_{0} \qquad [ Equation 7 ]$$

(where, Z_{IN_HCN1} is the input impedance of the first harmonic impedance control circuit, Z_{0_HCN1} is the characteristic impedance of the first transmission line in the first harmonic impedance control circuit, Z_{IN_TL2,TL3} is the input impedance measured at the third node, f₀ is a fundamental frequency, and f is a second harmonic frequency)

That is, by adjusting the thickness (the characteristic impedance) of the first transmission line 109-1, the thickness (the characteristic impedance) of the first open stub 109-2, and the thickness and electrical length of the second transmission line 109-3 using Equations 5, 6, and 7, the first diode 107 may be optimized to control the impedance to the second harmonic to 0 ohm.

Meanwhile, the thickness (the characteristic impedance) of the first transmission line 109-1 and the thickness (the characteristic impedance) of the first open stub 109-2 may be adjusted for 50 ohm matching of the fundamental frequency. In this process, the thickness of the first transmission line 109-1 and the first open stub 109-2 may change, which affects the input impedance of the first harmonic impedance control circuit 109, such that the second harmonic impedance may not be maintained at zero. Accordingly, by additionally adjusting the thickness and electrical length of the second transmission line 109-3, the second harmonic impedance should be restored back to zero.

That is, in order to simultaneously satisfy matching at the fundamental frequency and control of the second harmonic impedance, by optimizing the thickness of the first transmission line 109-1 and the first open stub 109-2, and the thickness and electrical length of the second transmission line 109-3 based on Equations 4 to 7, it is possible to control the second harmonic impedance to 0 ohm while matching the fundamental frequency to 50 ohms.

The second harmonic impedance control circuit 113 may be connected between the cathode of the second diode 111 and the output node 117.

In an exemplary embodiment, the second harmonic impedance control circuit 113 may include a third transmission line 113-1 of which one end is connected to the cathode of the second diode 111 and the other end is connected to a fourth node 113-4, a fourth transmission line 113-3 of which one end is connected to the fourth node 113-4 and the other end is connected to the output node 117, and a second open stub 113-2 connected to the fourth node 113-4.

That is, the second harmonic impedance control circuit 113 may control the third harmonic impedance to infinity through the third transmission line 113-1 and the second open stub 113-2 connected to the fourth node 113-4. In this case, the third transmission line 113-1 and the second open stub 113-2 may have a length of one-quarter of the third harmonic wavelength (2). In addition, the second harmonic impedance control circuit 113 may control the second harmonic impedance to 0 ohm through the third transmission line 113-1, the second open stub 113-2, and the fourth transmission line 113-3 connected in series to the third transmission line 113-1. In this case, for the third transmission line 113-1, the thickness of the second open stub 113-2, and the thickness and length of the fourth transmission line 113-3, a thickness of the third transmission line 113-1, a thickness of the second open stub 113-2, and a thickness and length of the fourth transmission line 113-3 may be determined through an optimization process based on an impedance formula so that the second harmonic impedance is controlled to 0 ohm.

Hereinafter, a process of controlling the third harmonic impedance using the second harmonic impedance control circuit 113 will be described.

Equation 8 below is a formula that represents the basic impedance relationship.

$${Z}_{IN \_ HCN 2} = {Z}_{0 \_ HCN 2} \frac{{Z}_{L \_ HCN 2} + {jZ}_{0 \_ HCN 2} tan ( \frac{π}{6} \frac{f}{{f}_{0}} )}{{Z}_{0 \_ HCN 2} + {jZ}_{L \_ HCN 2} tan ( \frac{π}{6} \frac{f}{{f}_{0}} )} at \\ f = 3 {f}_{0} \qquad [ Equation 8 ]$$

(where, Z_{IN_HCN2} is the input impedance of the second harmonic impedance control circuit, Z_{0_HCN2} is the characteristic impedance (thickness) of the third transmission line in the second harmonic impedance control circuit, Z_{L_HCN2} is the load impedance of the second harmonic impedance control circuit, f₀ is a fundamental frequency, and f is a third harmonic frequency)

In this case, since the load impedance to the third harmonic is represented as 0 by the second open stub 113-2, Equation 8 may be defined as Equation 10 below by Equation 9 below.

$${Z}_{IN \_ TL 5} = \frac{{Z}_{0 \_ TL 5}}{j tan ( \frac{π}{6} \frac{f}{{f}_{0}} )} at f = 3 {f}_{0} \qquad [ Equation 9 ]$$

(where, Z_{IN_TL5} is the input impedance of the second open stub and Z_{0_TL5} is the characteristic impedance (thickness) of the second open stub)

$${Z}_{IN \_ HCN 2} = {jZ}_{0 \_ HCN 2} tan ( \frac{π}{6} \frac{f}{{f}_{0}} ) at f = 3 {f}_{0} \qquad [ Equation 10 ]$$

In this case, since the second transmission line 113-1 is designed to have a length of one-quarter of the third harmonic wavelength, the second diode 111 may control the impedance to the third harmonic to infinity.

Hereinafter, a process of controlling the second harmonic impedance using the first harmonic impedance control circuit 113 will be described.

Equation 11 below is a formula representing the input impedance Z_{IN} of the rectifier according to the voltage multiplier structure.

$${Z}_{IN} = ( {Z}_{IN \_ HCN 1} ‖ {Z}_{IN \_ HCN 2} ) + Z ( {C}_{blk} ) at f = {f}_{0} \qquad [ Equation 11 ]$$

In order to control the second harmonic impedance to 0, the input impedance measured at the fourth node 113-4 (the input impedance measured at the point where the second open stub 113-2 and the fourth transmission line 113-3 are connected in parallel) should be controlled.

In this case, the input impedances of the second open stub 113-2 and the fourth transmission line 113-3 may be defined as in Equations 12 and 13 below, respectively.

$${Z}_{IN \_ TL 5} = \frac{{Z}_{0 \_ TL 5}}{j tan ( \frac{π}{6} \frac{f}{{f}_{0}} )} at f = 2 {f}_{0} \qquad [ Equation 12 ]$$

(where, Z_{IN_TL5} is the input impedance of the second open stub and Z_{0_TL5} is the characteristic impedance (thickness) of the second open stub)

$${Z}_{IN \_ TL 6} = {Z}_{0 \_ TL 6} \frac{{Z}_{L \_ TL 6} + {jZ}_{0 \_ TL 6} tan ( \frac{27 π}{200} \frac{f}{{f}_{0}} )}{{Z}_{0 \_ TL 6} + {jZ}_{L \_ TL 6} tan ( \frac{27 π}{200} \frac{f}{{f}_{0}} )} at f = 2 {f}_{0} \qquad [ Equation 13 ]$$

(where, Z_{IN_TL6} is the input impedance of the fourth transmission line and Z_{0_TL6} is the characteristic impedance (thickness) of the fourth transmission line)

Based on the input impedances of the second open stub 113-2 and the fourth transmission line 113-3, the input impedance Z_{IN_TL5,TL6} measured at the fourth node 113-4 may be calculated. Using the calculated input impedance, the first diode 107 may be optimized to control the impedance to the second harmonic to 0 ohm based on Equation 14 below.

$${Z}_{IN \_ HCN 2} = {Z}_{0 \_ HCN 2} \frac{{Z}_{IN \_ TL 5 , TL 6} + {jZ}_{0 \_ HCN 2} tan ( \frac{π}{6} \frac{f}{{f}_{0}} )}{{Z}_{0 \_ HCN 2} + {jZ}_{IN \_ TL 5 , TL 6} tan ( \frac{π}{6} \frac{f}{{f}_{0}} )} at \\ f = 2 {f}_{0} \qquad [ Equation 14 ]$$

(where, Z_{IN_HCN2} is the input impedance of the second harmonic impedance control circuit, Z_{0_HCN2} is the characteristic impedance (thickness) of the third transmission line in the second harmonic impedance control circuit, Z_{IN_TL5,TL6} is the input impedance measured at the fourth node, f₀ is a fundamental frequency, and f is a second harmonic frequency)

That is, by adjusting the thickness (the characteristic impedance) of the third transmission line 113-1, the thickness (the characteristic impedance) of the second open stub 113-2, and the thickness and electrical length of the second transmission line 113-3 using Equations 12, 13, and 14, the second diode 111 may be optimized to control the impedance to the second harmonic to 0 ohm.

Meanwhile, the thickness (the characteristic impedance) of the third transmission line 113-1 and the thickness (the characteristic impedance) of the second open stub 113-2 may be adjusted for 50 ohm matching of the fundamental frequency. In this process, the thickness of the third transmission line 113-1 and the second open stub 113-2 may change, which affects the input impedance of the second harmonic impedance control circuit 113, such that the second harmonic impedance may not be maintained at 0. Accordingly, by additionally adjusting the thickness and electrical length of the fourth transmission line 113-3, the second harmonic impedance should be restored back to zero.

That is, in order to simultaneously satisfy matching at the fundamental frequency and control of the second harmonic impedance, by optimizing the thickness of the third transmission line 113-1 and the second open stub 113-2, and the thickness and electrical length of the fourth transmission line 113-3 based on Equations 11 to 14, it is possible to control the second harmonic impedance to 0 ohm while matching the fundamental frequency to 50 ohms.

In this way, the input impedance at the first diode 107 and the input impedance at the second diode 111 are adjusted by the first harmonic impedance control circuit 109 and the second harmonic impedance control circuit 113, respectively, so that the input impedance at the input node 101 (the input impedance seen by the input node 101) is matched to 50 ohms at the fundamental frequency.

The output node 117 may provide the rectified electrical signal to an external load. For example, an external load may be connected to the output node 117. In this case, the rectified electrical signal may be in a state where the voltage is amplified by the second capacitor 119 connected to the second node 115, and may be a DC signal by a DC pass filter 121 connected to the second node 115.

Therefore, according to embodiments of the present disclosure, the second and third harmonic impedances can be independently controlled in each of the diodes 107 and 111 using the first and second harmonic impedance control circuits 109 and 113 based on the voltage multiplier structure, and can be matched to 50 ohms at the fundamental frequency without an additional fundamental matching stage.

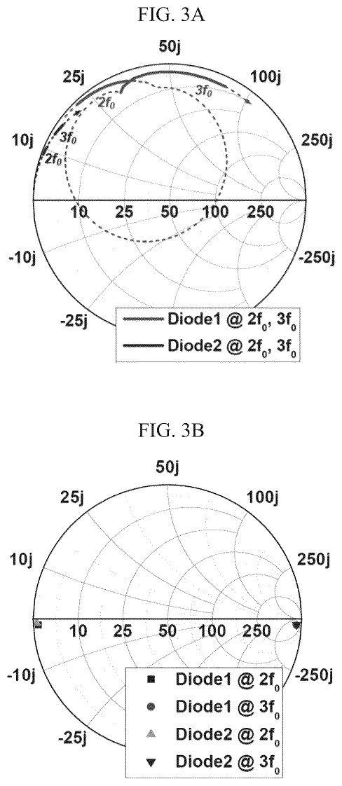

FIGS. 3A to 6 are diagrams showing simulation results of a rectifier with an impedance control circuit according to an embodiment of the present disclosure.

In FIGS. 3A and 3B, FIG. 3A shows changes in the second and third harmonic impedances in each diode of a rectifier without an impedance control circuit, and FIG. 3B shows changes in the second and third harmonic impedances in each diode of a rectifier with an impedance control circuit, respectively. That is, as in FIG. 3A, it can be confirmed that when there is no impedance control circuit, the second and third harmonic impedances are not controlled at all, and as in FIG. 3B, it can be confirmed that when there is an impedance control circuit, the second harmonic impedance is controlled to 0 ohm and the third harmonic impedance is controlled to infinity. In this way, it can be confirmed that, in the rectifier with the impedance control circuit according to an embodiment of the present disclosure, the second and third harmonic impedances are independently and precisely controlled in each diode.

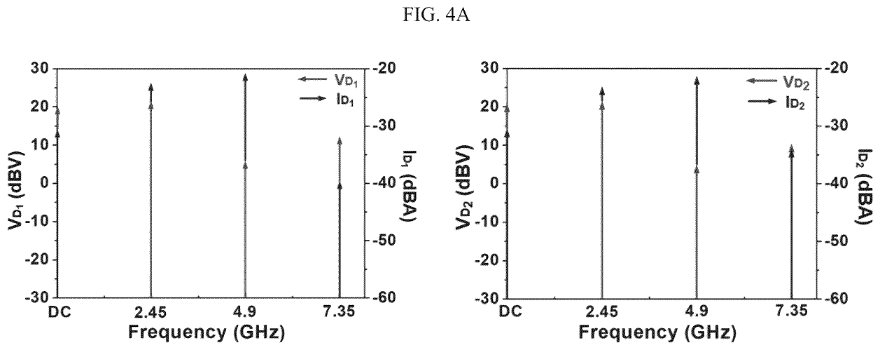

In FIGS. 4A and 4B, FIG. 4A shows the frequency spectrum of voltage and current in each diode of a rectifier without an impedance control circuit, and FIG. 4B shows the frequency spectrum of voltage and current in each diode of a rectifier with an impedance control circuit. That is, when FIGS. 4A and 4B are compared, in the case of the rectifier with an impedance control circuit, it was confirmed that the harmonic voltage applied to each diode at the second harmonic frequency of 4.9 GHz is reduced by 12 dB and 11.6 dB and the harmonic current applied to each diode at the third harmonic frequency of 7.35 GHz is reduced by 14.5 dB and 20.8 dB. In this way, it can be confirmed that the rectifier with an impedance control circuit according to an embodiment of the present disclosure precisely controls the harmonic impedance in each diode independently and effectively suppresses the harmonic voltage and current, and it can be confirmed that power conversion efficiency can be maximized by reducing harmonic power consumption.

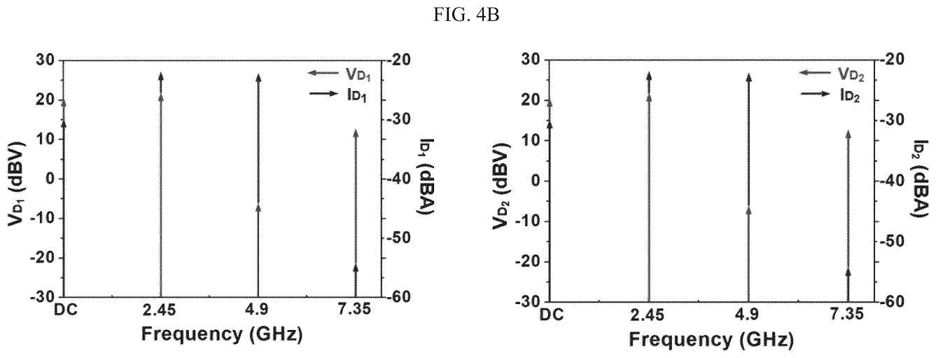

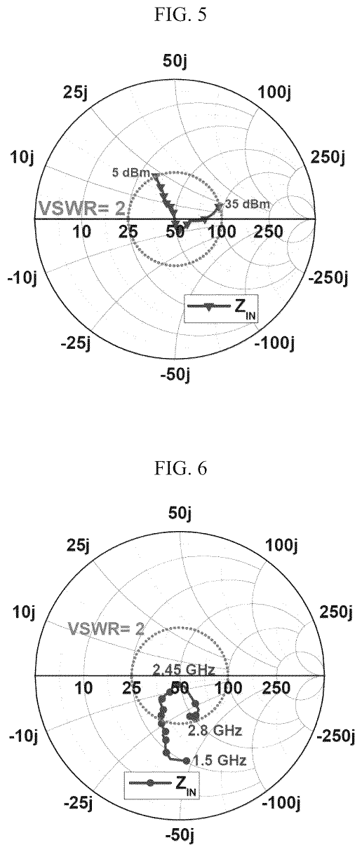

FIG. 5 shows the input impedance change at the fundamental frequency according to the input power, and FIG. 6 shows the input impedance change according to the frequency change. As shown in FIG. 5, it can be confirmed that the rectifier with the impedance control circuit according to an embodiment of the present disclosure can be matched to 50 ohms at the fundamental frequency without an additional fundamental matching stage. In addition, as shown in FIG. 6, it can be confirmed that the rectifier with the impedance control circuit according to an embodiment of the present disclosure exhibits a small amount of change in input impedance according to the frequency change. That is, it can be confirmed that the impedance change rate according to frequency fluctuation is low through the voltage multiplier structure.

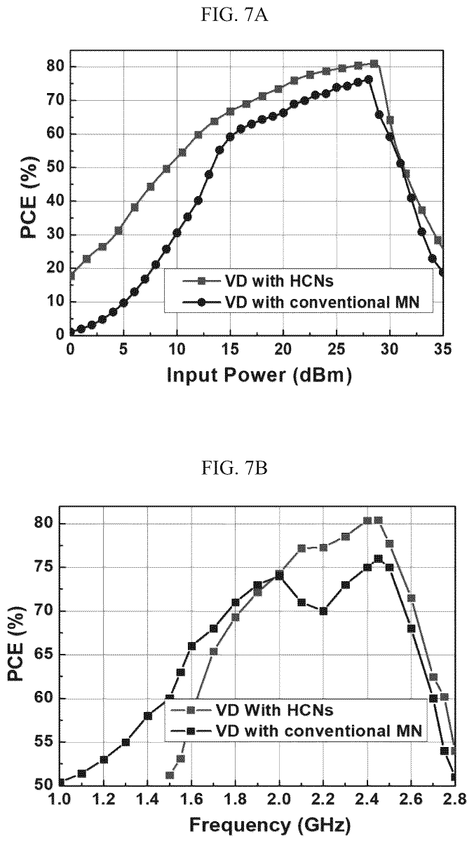

FIGS. 7A and 7B are diagrams showing the performance characteristics of the rectifier with the impedance control circuit according to an embodiment of the present disclosure.

FIGS. 7A and 7B show the difference in power conversion efficiency according to FIG. 7A input power and FIG. 7B frequency change when comparing a rectifier with an impedance control circuit and a rectifier with only a fundamental matching stage. That is, as in FIG. 7A, it can be confirmed that the maximum power conversion efficiency is improved by 6% compared to the conventional one, and it can be confirmed that the input power range where the power conversion efficiency is 50% is expanded by 6 dB. In addition, as in FIG. 7B, it can be confirmed that the wideband characteristics are excellently maintained. In this way, it can be confirmed that the rectifier with the impedance control circuit according to an embodiment of the present disclosure can effectively improve the power conversion efficiency even under various input power and frequency change conditions, and can stably maintain high performance in a wide operating range.

According to embodiments of the present disclosure, the second and third harmonic impedances can be independently controlled in each diode based on a voltage multiplier structure, and can be matched to 50 ohms at the fundamental frequency without an additional fundamental matching stage.

Although representative embodiments of the present disclosure have been described in detail above, those skilled in the art will understand that various modifications may be made to the embodiments described above without departing from the scope of the present disclosure. Therefore, the scope of the rights of the present disclosure should not be limited to the described embodiments, but should be determined by the claims described below as well as equivalents of the claims.

What is claimed is:

1. A rectifier comprising:
an input node;
an output node;
a first diode connected to the input node and a ground terminal; and
a second diode connected to the input node and the output node,
wherein the rectifier further comprises:
a first harmonic impedance control circuit connected to the first diode and the ground terminal and configured to control second and third harmonic impedances in the first diode; and
a second harmonic impedance control circuit connected to the second diode and the output node and configured to second and third harmonic impedances in the second diode.

2. The rectifier of claim 1, further comprising:
a first capacitor configured to block a DC component of an electrical signal provided from the input node;
a DC pass filter connected to the second harmonic impedance control circuit and the output node; and
a second capacitor connected to the second harmonic impedance control circuit and configured to amplify a voltage of the electrical signal.

3. The rectifier of claim 1, wherein the first harmonic impedance control circuit further includes:
a first transmission line of which one end is connected to an anode of the first diode and the other end is connected to a first node;
a second transmission line of which one end is connected to the first node and the other end is connected to the ground terminal; and
a first open stub of which one end is connected to the first node and which is connected in parallel with the second transmission line.

4. The rectifier of claim 3, wherein the first transmission line and the first open stub have a length obtained by dividing a wavelength corresponding to the third harmonic frequency in the first diode by four so that the third harmonic impedance in the first diode is controlled to infinity by the first harmonic impedance control circuit.

5. The rectifier of claim 4, wherein the first transmission line, the first open stub, and the second transmission line have adjusted values of a thickness of the first transmission line, a thickness of the first open stub, and a thickness and length of the second transmission line so that the second harmonic impedance in the first diode is controlled to 0 ohm by the first harmonic impedance control circuit.

6. The rectifier of claim 5, wherein the thickness of the first transmission line, the thickness of the first open stub, and the thickness and length of the second transmission line are adjusted so that an input impedance measured at the first node is calculated based on Equations 1 and 2, and an impedance to the second harmonic at the first diode is 0 ohm based on Equation 3:
$${Z}_{IN \_ TL 2} = \frac{{Z}_{0 \_ TL 2}}{j tan ( \frac{π f}{6 {f}_{0}} )} at f = 2 {f}_{0} \qquad [ Equation 1 ]$$
where Z_{IN_TL2} is input impedance of first open stub, Z_{0_TL2} is characteristic impedance (thickness) of first open stub;
$${Z}_{IN \_ TL 3} = {jZ}_{0 \_ TL 3} tan ( \frac{7 π}{36} \frac{f}{{f}_{0}} ) at f = 2 {f}_{0} \qquad [ Equation 2 ]$$
where Z_{IN_TL3} is input impedance of second transmission line, Z_{0_TL3} is characteristic impedance (thickness) of second transmission line; and
$${Z}_{IN \_ HCN 1} = {Z}_{0 \_ HCN 1} \frac{{Z}_{IN \_ TL 2 , TL 3} + {jZ}_{0 \_ HCN 1} tan ( \frac{π f}{6 {f}_{0}} )}{{Z}_{0 \_ HCN 1} + {jZ}_{IN \_ TL 2 , TL 3} tan ( \frac{π f}{6 {f}_{0}} )} at \\ f = 2 {f}_{0} \qquad [ Equation 3 ]$$
where Z_{IN_HCN1} is input impedance of first harmonic impedance control circuit, Z_{0_HCN1} is characteristic impedance of first transmission line in first harmonic impedance control circuit, Z_{IN_TL2,TL3} is input impedance measured at first node, f₀ is fundamental frequency, and f is second harmonic frequency.

7. The rectifier of claim 6, wherein the first transmission line, the second transmission line and the first open stub have adjusted values of the thickness of the first transmission line, the thickness of the first open stub and the thickness and length of the second transmission line so that the input impedance at the input node is matched to 50 ohms at the fundamental frequency by adjusting the input impedance at the first diode by the first harmonic impedance control circuit.

8. The rectifier of claim 1, wherein the second harmonic impedance control circuit further includes:
a third transmission line of which one end is connected to a cathode of the second diode and the other end is connected to a second node;
a fourth transmission line of which one end is connected to the second node and the other end is connected to the output node; and
a second open stub of which one end is connected to the second node and which is connected in parallel with the fourth transmission line.

9. The rectifier of claim 8, wherein the third transmission line and the second open stub have a length obtained by dividing a wavelength corresponding to the third harmonic frequency in the second diode by four so that the third harmonic impedance in the second diode is controlled to infinity by the second harmonic impedance control circuit.

10. The rectifier of claim 9, wherein the third transmission line, the second open stub, and the fourth transmission line have adjusted values of a thickness of the third transmission line, a thickness of the second open stub, and a thickness and length of the fourth transmission line so that the second harmonic impedance in the second diode is controlled to 0 ohm by the second harmonic impedance control circuit.

11. The rectifier of claim 10, wherein the thickness of the third transmission line, the thickness of the second open stub, and the thickness and length of the fourth transmission line are adjusted so that an input impedance measured at the second node is calculated based on Equations 4 and 5, and an impedance to the second harmonic at the second diode is 0 ohm based on Equation 6:
$${Z}_{IN \_ TL 5} = \frac{{Z}_{0 \_ TL 5}}{j tan ( \frac{π f}{6 {f}_{0}} )} at f = 2 {f}_{0} \qquad [ Equation 4 ]$$
where, Z_{IN_TL5} is input impedance of second open stub, Z_{0_TL5} is characteristic impedance (thickness) of second open stub;
$${Z}_{IN \_ TL 6} = {Z}_{0 \_ TL 6} \frac{{Z}_{L \_ TL 6} + {jZ}_{0 \_ TL 6} tan ( \frac{27 π f}{200 {f}_{0}} )}{{Z}_{0 \_ TL 6} + {jZ}_{L\_ TL 6} tan ( \frac{27 π f}{200 {f}_{0}} )} at f = 2 {f}_{0} \qquad [ Equation 5 ]$$
where, Z_{IN_TL6} is input impedance of fourth transmission line, Z_{0_TL6} is characteristic impedance (thickness) of fourth transmission line; and
$${Z}_{IN \_ HCN 2} = {Z}_{0 \_ HCN 2} \frac{{Z}_{IN \_ TL 5 , TL 6} + {jZ}_{0 \_ HCN 2} tan ( \frac{π f}{6 {f}_{0}} )}{{Z}_{0 \_ HCN 2} + {jZ}_{IN \_ TL 5 , TL 6} tan ( \frac{π f}{6 {f}_{0}} )} at \\ f = 2 {f}_{0} \qquad [ Equation 6 ]$$
where, Z_{IN_HCN2} is input impedance of second harmonic impedance control circuit, Z_{0_HCN2} is characteristic impedance of third transmission line in second harmonic impedance control circuit, Z_{IN_TL5,TL6} is input impedance measured at the second node, f₀ is fundamental frequency, and f is second harmonic frequency.

12. The rectifier of claim 11, wherein the third transmission line, the second open stub, and the fourth transmission line have adjusted values of the thickness of the third transmission line, the thickness of the second open stub, and the thickness and length of the fourth transmission line so that the input impedance at the input node is matched to 50 ohms at the fundamental frequency by adjusting the input impedance at the second diode by the second harmonic impedance control circuit.
